(19) United States
(12) Patent Application Publication
(10) Pub. No.: US 2014/0074547 A1
(43) Pub. Date: Mar. 13, 2014

(54) PERSONAL AND WORKFORCE REPUTATION PROVENANCE IN APPLICATIONS

(71) Applicant: ORACLE INTERNATIONAL CORPORATION, Redwood Shores, CA (US)

(72) Inventors: REZA B'FAR, HUNTINGTON BEACH, CA (US); KENT SPAULDING, PORTLAND, OR (US); YASIN CENGIZ, IRVINE, CA (US); SREEDHAR CHITULLAPALLY, IRVINE, CA (US); ALAN WAXMAN, MORGANVILLE, NJ (US); YENAL KAL, IRVINE, CA (US)

(21) Appl. No.: 13/932,286

(22) Filed: Jul. 1, 2013

Related U.S. Application Data
(60) Provisional application No. 61/699,250, filed on Sep. 10, 2012.

(51) Int. Cl. G06Q 10/06

(52) U.S. Cl. CPC G06Q 10/0635
USPC 705/7.28

(57) ABSTRACT

Techniques for storing information include making determinations whether to store data from a data source based at least in part on one or more reputation metrics calculated for an individual associated with the information. The scope of information collected about an individual is varied based on the individual's reputation and/or the reliability of the source of information, which may be a social network system or other data source.

### CROSS-REFERENCES TO RELATED APPLICATIONS

The present application claims benefit under 35 USC 119(e) of U.S. Provisional Application No. 61/699,250, filed on Sep. 10, 2012 by B′Far et al. and entitled “Personal and Workforce Reputation Provenance in Applications,” of which the entire disclosure is incorporated herein by reference for all purposes.

The present application is also related to the following co-pending and commonly assigned U.S. patent applications:
U.S. patent application Ser. No. ______ (Attorney Docket Number 88325-857738(130900US)) filed concurrent herewith by B'Far et al. and entitled “Advanced Skill Match and Reputation Management for Workforces,” and which claims priority to U.S. Provisional Application No. 61/699,233, filed on Sep. 10, 2012 by B′Far et al. and entitled “Advanced Skill Match and Reputation Management for Workforces;”
U.S. patent application Ser. No. ______ (Attorney Docket Number 88325-857742(131200US)) filed concurrent herewith by B'Far et al. and entitled “Reputation-Based Auditing of Enterprise Application Authorization Models,” and which claims priority to U.S. Provisional Application No. 61/699,238, filed on Sep. 10, 2012 by B'Far et al. and entitled “Reputation-Based Auditing of Enterprise Application Authorization Models;” and
U.S. patent application Ser. No. ______ (Attorney Docket Number 88325-857743(131300US)) filed concurrent herewith by B'Far et al. and entitled “Semi-Supervised Identity Aggregation of Profiles Using Statistical Methods,” and which claims priority to U.S. Provisional Application No. 61/699,243, filed on Sep. 10, 2012 by B'Far et al. and entitled “Semi-Supervised Identity Aggregation of Profiles Using Statistical Methods,” of which the entire disclosure of each is incorporated herein by reference for all purposes.

### BACKGROUND OF THE INVENTION

Modern communications technologies provide numerous opportunities for individuals and organizations to communicate with others in electronic environments. Social networks, for example, allow individual organizations to communicate with groups of individuals and even the general public. Web sites and other electronic information resources often allow members of the public to provide their own content, such as product reviews, opinions on certain topics, technical assistance, photographs, audio files, video files, and other types of content. In addition, the diverse ways in which modern communication technologies operate provides opportunities to gain valuable intelligence that would not otherwise be as freely available. For instance, social networks often allow users to mutually associate themselves with one another. This allows, for example, the collection of information not only about an individual, but other individuals who have some sort of relationship with the individual. As such, effective use of such communications have the potential to have significant positive effects for the conduct of one's business.

At the same time, the ability to freely communicate using modern technologies has the potential to cause significant harmful effects on one's business. For instance, the conduct of an individual in a public forum can contribute to shaping others' opinion of an organization associated with the individual. While this can be a positive effect in many instances, unsavory and/or unpopular behavior of the individual can negatively affect the organization. For instance, if an employee of a company uses excessive amounts of profanity and provides negative opinions of his or her employer in public forums, the company can suffer reputational harm, thereby affecting the company's good will with the general public. As another example, if the employee publically posts information related to confidential dealings of the company, the company can find itself addressing various legal issues, such as securities laws violations. Thus, while modern communications provide numerous opportunities for an organization, such opportunities are not without significant risks.

One way to address both the benefits and risks of modern communications technologies to an organization is to collect, store, and analyze data related to the activities of those involved in an organization. The amounts of data, however, can be vast. To collect, analyze, and store such amounts of data can be extremely resource intensive. Moreover, much collectible data is likely benign. For example, a public online post in a social network offering birthday wishes to a friend is unlikely to affect an organization positively or negatively, whereas an online post in the social network discussing confidential acquisition discussions may have a significant negative effect. Conventional techniques for managing data often are inadequate for effectively collecting and analyzing data.

### BRIEF SUMMARY OF THE INVENTION

Embodiments of the invention provide systems and methods for storing information include making determinations whether to store data from a data source based at least in part on one or more reputation metrics calculated for an individual associated with the information. The scope of information collected about an individual is varied based on the individual's reputation and/or the reliability of the source of information, which may be a social network system or other data source.

Stated another way, dynamically managing an amount of provenance data collected for employees of an enterprise can comprise maintaining a reputation score for an employee of the enterprise. The reputation score can comprise an indication of a risk associated with the employee. More specifically, maintaining the reputation score for the employee can comprise obtaining information associated with the employee from each of a plurality of data sources. The plurality of data sources can include at least one data source internal to the enterprise and at least one data source external to the enterprise.

A semantic analysis can be performed on the obtained information and a trustworthiness score can be calculated for the obtained information. The trustworthiness score can indicate whether the source of the obtained information is likely to be associated with the employee. The trustworthiness score can be related to one or more of the source of information, the author of the information, or the reputation of the source or the author of the information. One or more reputation scores can be mapped to a single trustworthiness score. The trustworthiness score can be stored with the stored information and as part of the provenance information for use in further analysis.

The reputation score for the employee can be obtained and a determination can be made as to whether to store the obtained information based at least in part on the semantic analysis, the trustworthiness score, and the reputation score. In some cases, maintaining the reputation score for the employee can further comprise obtaining authorization information. The authorization information can be used to obtain the information associated with the employee from each of the plurality of data sources. One or more keys can be generated using the authorization information. The obtained information about the employee can be encrypted using the generated one or more keys and the encrypted obtained information about the employee can be saved.

After the reputation score has been determined, a change can be detected in the reputation score for the employee. A scope of the set of provenance data collected for the employee can be changed based on detecting the change in the reputation score for the employee when the detected change exceeds a threshold amount of change. Changing the scope of the set of provenance data collected for the employee can comprise increasing the scope of the set of provenance data collected for the employee when the reputation score for the employee increases and decreasing the scope of the set of provenance data collected for the employee when the reputation score for the employee decreases. For example, changing the scope of the set of provenance data collected for the employee can comprise modifying one or more aspects of storing data related to the employee in a reputation database, changing one or more conditions for storing data related to the employee in a reputation database and one or more sources of the data related to the employee, and/or changing one or more sources of data related to the employee.

### BRIEF DESCRIPTION OF THE DRAWINGS

FIG. 1 shows an illustrative example of an environment in which various embodiments of the present disclosure may be practiced;

FIG. 2 shows an alternative illustrative example of the environment of FIG. 1 in which various embodiments of the present disclosure may be practiced;

FIG. 3 shows example steps of a process varying the scope of provenance data collection in accordance with at least one embodiment;

FIG. 4 shows example steps of a process for selectively storing data in accordance with at least one embodiment;

FIG. 5 shows example steps of a process for securely storing data in accordance with at least one embodiment; and

FIG. 6 shows an example computer system that may be used to implement various aspects of the present disclosure.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

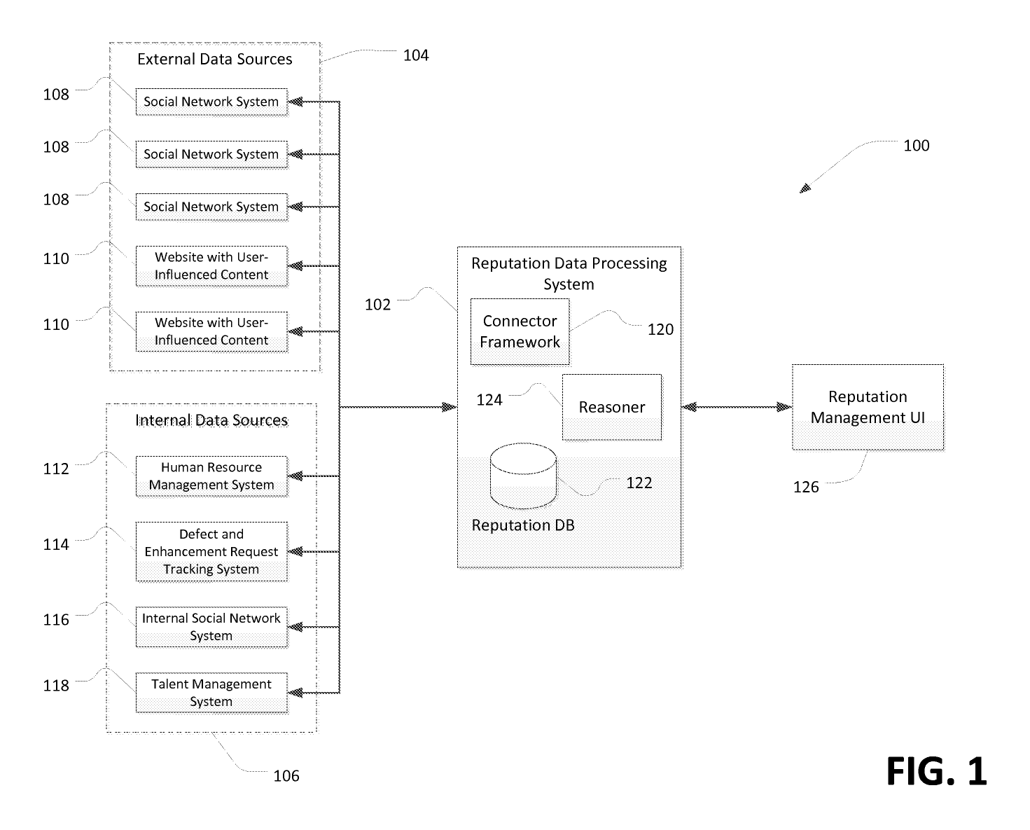

FIG. 1 shows an illustrative example of an environment 100 in which various embodiments of the present disclosure may be practiced. In this example, the environment 100 includes a reputation data processing system 102. The reputation data processing system 102 may be one or more computer systems collectively configured to operate in accordance with various embodiments of the present disclosure, such as those embodiments discussed below. An example of such computer system is described below in connection with FIG. 11. In the illustrative example of FIG. 1, the reputation data processing system is configured to obtain data from external data sources 104 and internal data sources 106.

The reputation data processing system 102 may be operated by an organization or on behalf of the organization. As such, external data sources 104 may be computer systems serving as a source of data where the computer systems are operated by and/or on behalf of entities different from the organization. Similarly, internal data sources 106 may be computer systems serving as sources of data where the computer systems are operated by and/or on behalf of the organization. It should be noted that the various data sources, internal and external, may be hosted in various ways. For example, one or more of the internal data sources may be hosted by the organization itself, such as in a data center or other facility of the organization. One or more of the internal data sources may be hosted by third parties. For example, one or more of the internal data sources may operate using facilities and hardware of a third party, yet may be programmatically managed by or on behalf of the organization. The hosting of external data sources may also vary in these ways.

Turning to the external data sources, example data sources include social network systems 108. A social networking system may be a publicly accessible computer system having users from the general public. The term “computer system,” unless otherwise contradicted explicitly or by context, is intended to encompass both single computer instances (e.g. a single server) and multiple computer system instances, such as a network of computer system instances that collectively operate to achieve a result. Further, a computer system may also encompass multiple computer system instances that span multiple geographic regions and/or data center facilities. Returning to an example social networking system 108, the users of the social networking system may have accounts and corresponding profiles with the social network systems 108 and may engage in social networking activities. Example social networking activities include communicating electronically with other users of a social network system, either privately or publicly, expressing interest in content, and/or associating profiles with other profiles of the social network system which may be pursuant to mutual acceptance of the association by corresponding users. Specific examples of social networking systems include Facebook®, Twitter®, MySpace®, and others. Some specific examples of social networking activities in the Facebook social network system include friending other users, posting content on another's wall, liking content and/or other users, public or private messaging, un-friending other users, sharing content, and other activities. Example activities in the Twitter social network system include following other users, being followed by other users, tweeting, re-tweeting, and the like.

Generally, any suitable external data source may be used in accordance with various embodiments of the present disclosure. For example, as illustrated in FIG. 1, various websites 110 with user-influenced content may also serve as external data sources for the reputation data processing system 102. A website with user-influenced content may be any public information resource in which content is associated with users of the website. An example website may be an online forum in which users of the forum submit messages for other users to see. Another example of a suitable website is an electronic marketplace in which users of the electronic marketplace are able to electronically provide feedback for other users of the electronic marketplace. For example, one user may purchase a product or otherwise have knowledge of the product and may provide an electronic review of the product for other users to see in connection with their purchasing decisions.

As with external data sources 104, internal data sources 106 may comprise one or more computer systems serving as an internal source of data for the reputation data processing system 102. Typically, organizations utilize various computer systems in connection with management of their operations. An organization, for example, may utilize various computer systems for accounting, human resources, talent management, customer relationship management, internal social networking, internal information sources (e.g. internal websites), and the like. FIG. 1 shows some illustrative examples of suitable internal data sources 106 in accordance with an embodiment. For example, as shown in FIG. 1, the internal data sources 106 include a human resource management system 112 which may be a computer system configured to perform various operations in connection with management of an organization's human resource needs.

The human resource management 112 may, for example, maintain data about employees of the organization and may allow administrators to update, add, and/or remove data for employees of the organization as the set of employees of the organization changes over time. Another example of a suitable internal data source 106 is a defect and enhancement request tracking system 114. A defect and enhancement request tracking system 114 may be a computer system which tracks various issues with products and/or services of the organization. For example, if the organization is a software company, the defect and enhancement request tracking system may enable employees to submit information identifying issues with the software otherwise known as bugs. The defect and enhancement request tracking system may also enable employees to submit information regarding bugs of internal computer systems used by the organization and not necessarily sold to others. For example, an employee may notice a broken link on an internal web page of the organization and, as a result, may submit a ticket which may then be processed by another employee of the organization who may update the internal website accordingly.

As illustrated in FIG. 1, the internal data sources also include an internal social network system 116. The internal social network system 116 may not be publicly accessible. That is, the universe of users of the internal social network system 116 may be limited, such as to employees of the organization, certain employees of the organization and/or individuals and/or computer systems to which the organization has provided authorization. As an example, the internal social network system 116 may be accessible to employees of the organization and certain vendors of the organization such as attorneys working in law firms for the organization. It should be noted and understood that, while referred to here as an “internal” social network system, this system may or may not be hosted internally. That is, it may actually be a hosted outside the company, but have a limited universe of employees, i.e., accessible by internal people.

Also as illustrated in FIG. 1, the internal data sources 106 include a talent management system 118. A talent management system may be a computer system configured to enable employees of the organization to perform various operations in connection with ensuring that the organization has appropriate personnel. For example, an employee of the organization may utilize the talent management system to track individuals who are engaged in the hiring process of the organization and/or to locate candidates for open positions. The talent management system may maintain resumes, may perform automated processing of received resumes, and the like. Example talent management systems include those offered under the brand name Taleo. It should be noted and understood that this system might be hosted elsewhere, but would considered “internal” in the sense that only “internal” people have access to this system.

As noted above, numerous variations of the environment 100 are considered as being within the scope of the present disclosure. For example, while FIG. 1 shows various illustrative examples of external data sources 104 and internal data sources 106, numerous embodiments of the present disclosure may have more or fewer data sources than those explicitly illustrated.

Turning to the reputation data processing system 102, in an embodiment, the system includes multiple components. For example, as illustrated in FIG. 1, the reputation data processing system 102 includes a connecter framework 120. The connector framework 120 of the reputation data processing system 102 may be a component (e.g. separate computer system instance(s) or programming module) configured to enable the reputation data processing system 102 to obtain data from the external data sources 104 and internal data sources 106. The connector framework 120 may, for example, operate according to programming logic that enables the connector framework 120 to obtain data from numerous different data sources and combine the data in a manner suitable for processing by the reputation data processing system such as described below.

For example, many of the external data sources 104 and/or internal data sources 106 may provide data that is organized in different ways. The connector framework 120 may include programming logic to extract data and store data from multiple sources in a common manner such as in accordance with a common data storage schema. The connector framework may obtain data from the various data sources in numerous ways. For example, in an embodiment, the connector framework is configured to obtain data from the various data sources according to application programming interfaces (APIs) of the various systems. For example, a social network system 108 may include an API for obtaining data available in the API. The connector framework may include programming logic for making API calls in a manner acceptable to the social network system. Different social network systems may have different APIs and the connecter framework may be configured appropriately to obtain data from the different sources.

The connector framework 120 may also be configured to obtain data in other ways. For example, data posted on web pages may be obtained by downloading web pages or other documents of the data source. For instance, a website may correspond to a domain name. The connector framework 120 may enable the reputation data processing system to obtain a web page or other document by using the URL. The connector framework may analyze and receive documents and store data accordingly. The connector framework 120 may also utilize various screen scraping techniques and generally any technique in which data from a data source may be obtained.

As noted above, the connector framework 120 in an embodiment enables the reputation data processing system to obtain data from various different sources and store the data according to a common schema or generally in a manner suitable for use by the reputation data processing system. In an embodiment as illustrated in FIG. 1, the data received through the connector framework 120 is stored by the reputation data processing system into a reputation database 122. The reputation database may be any data storage mechanism that enables the reputation data processing system to operate in accordance with the various embodiments described herein.

The reputation database may, for example, be a relational database comprising a computer system that utilizes storage to store data in multiple tables, where the tables associate some of the data with other data. For example a table may associate an identifier of an employee with data collected about the employee, such as data regarding the employee's activity in a social network and/or other electronic environment. According to some embodiments, much of the collected data can be stored in a triple-store (aka a graph database) and the remainder in a relational database. In such a mixed model, data can be stored based on how it will be analyzed later, i.e., it can be stored where future analysis will be most efficient. Once data is obtained from multiple sources and stored in the reputation database 122, a reasoner 124 of the reputation data processing system may process data accessed from the reputation database 122. The reasoner accordingly may be a component of the reputation data processing system that is configured to analyze data from the reputation database in accordance with the various embodiments described herein.

The reasoner 124 may, for example, analyze data from the reputation database 122 in order to determine an individual influence based on the data that was obtained about the individual. Similarly, the reasoner 124 may be used to decide which data is stored persistently in the reputation database 122. For example, the connector framework 120 in an embodiment may obtain more data than is necessary and/or desirable for use in accordance with the various embodiments. The reasoner 124 may accordingly analyze data to determine whether to discard the data or store the data in the reputation database 122.

In an embodiment, the environment 100 includes a reputation management user interface 126, which enables users of the reputation data processing system 102 to engage in various activities, such as by defining data analysis for the data processing system 102 to perform, specifying data sources and which data is to be obtained from the specified data sources, specifying parameters for maintaining data (e.g. how much data to store for each user, how to determine which data to keep and which to discard, and the like), viewing presentations of data and results of analysis of the data by the reputation data processing system 102, generating white label applications for data sources, and other activities. In an embodiment, the reputation management user interface 126 is an application operating on a computer system instance separate from the reputation data processing system 102, obtaining data for presentations and/or the presentations themselves from the reputation data processing system 102. The reputation management user interface 126 may be an application constructed using application development framework (ADF) tools, such as those available from Oracle Corporation. However, the reputation management user interface 126 may be any suitable application and, in some embodiments, the reputation management user interface is presented in a web browser, presenting presentations obtained from a web server of the reputation data processing system 102 (e.g. in the form of HTML pages). Also, while illustrated separately from the reputation data processing system 102, the reputation management user interface 126 may be a component of the reputation data processing system 102. For example, if the reputation data processing system is operated as a server or cluster of servers, the reputation management user interface 126 may be a module of the reputation data processing system 102 implemented by the server and/or one or more of the servers of the cluster.

The reputation management user interface 126 may also be separate from the reputation data processing system 102. For instance, the reputation management user interface 126 may be implemented by a server different from a server or cluster of servers that implements the reputation data processing system 102. Similarly, the reputation management user interface may be implemented as multiple components implemented themselves on different hardware devices. For example, the reputation management user interface 126 may be implemented collectively by a server and a client application executing on a hardware device of a user of the reputation management user interface 126. In an embodiment, the reputation management user interface enables users to view presentations of data and results of analysis of the data.

In an embodiment, the presentations presented by the reputation management user interface 126 include graphics and/or text which provide intuitive views of data in the reputation database and/or results of analysis of that data. In an embodiment, a user of the reputation management user interface provides user input that is transmitted to the reputation data processing system 102. The reasoner 124 may then process data from the reputation database 122 in accordance with the user input. Results of processing by the reasoner 124 may be provided to the reputation management user interface 126 for presentation to the user. Similarly, input by the user may be transmitted to the reputation data processing system 102 which may submit a query to the reputation database 122 to obtain data stored by the reputation database 122 which is then provided either directly or in a processed form to the reputation management user interface 126 for presentation to the user.

User input into the reputation management user interface 126 may also cause results from the reasoner 124 and data from the reputation database 122 to be provided for presentation to the user. Plus, in general, in an embodiment, the representation management user interface enables users to direct operation of the reputation data processing system 102 in accordance with its programmed capabilities. Additional capabilities may include, for example, obtaining data from a data source in response to user input provided to the reputation management user interface 126.

In various embodiments, the reputation management user interface 126 includes one or more additional features. For example, in an embodiment, the reputation management user interface 126 includes reusable ADF and/or API components that allow others to build additional applications that make use of data and analysis through the reputation data processing system 102. Reputation metrics and other values calculated by the reputation data processing system 102 may be used, for instance, to serve other purposes in addition to those described explicitly herein. For instance, reusable ADF components of the user interface 126 may be used to build a custom application for a marketing department to enable users in the marketing department to hone their skills and view how their activities serve their reputations and the reputations of the organization as well as how their activities may cause undue risk to the organization.

As another example, in some embodiments, the reputation management user interface 126 includes functionality to generate white label applications for one or more social networking systems and/or other system. A white label application built for a social network system may, for example, be installed by a user as a condition for receiving one or more rewards or other recognition. An example of such rewards may be a restaurant or retailer discounts. In such cases, if an employee shares more information, they may, in some embodiments, receive larger discounts, discounts at a larger set of retailers, or unlock extra coupon codes. Once installed, the white label application may give the organization access to information maintained by the social network system in a non-public manner. For example, using Facebook as an example, use of the white label application may give the organization access to information that is not accessible to the general public, but to a more limited group of Facebook users, such as those identified as friends of the user that installed the white label application. In an embodiment, the white label application allows the user to specify various privacy settings that determine how much and which types of information are shared with the organization. In some embodiments, the white label application is a wrapper for a benefit management application such that benefits to the employee may vary according to the amount of information shared by the employee. In this manner, the employee can choose the level of benefits and information sharing that he or she is most comfortable with.

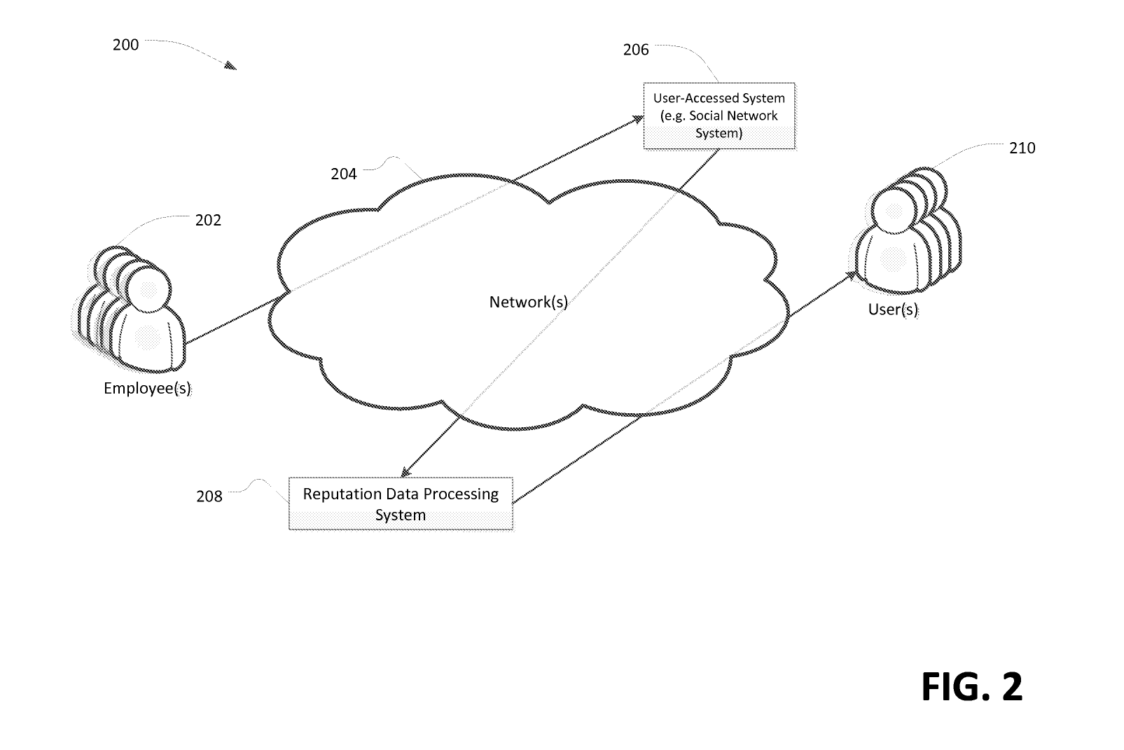

FIG. 2 shows an illustrative example of an environment 200 in which various embodiments of the present disclosure may be performed. Environment 200 may be the environment 100 described above in connection with FIG. 1 or another environment. In the environment 200, employees 202 of an organization utilize one or more networks 204 to access a user-accessed system 206. The network 204 may be the Internet and an intranet, a mobile communications network and generally any suitable communications network or combination of networks. User-accessed system 206 may be an internal or external data source such as described above. For example, in an embodiment the user-accessed system may be a social network system.

The employees 202 of the organization may access the user-accessed system using various devices. Example devices include: personal computer systems, mobile devices such as smart phones, tablet computing devices and generally any device configured to communicate with the user-accessed system 206. As shown in FIG. 2, a reputation data processing system 208, such as the reputation data processing system described above in connection with FIG. 1, obtains data from the user-accessed system 206. For example, the reputation data processing system 208 may submit an API call to the user-accessed system 206 which may provide a response accordingly with data specified by the API call.

For example, the reputation data processing system 208 in an embodiment may submit an API call to obtain data about an employee 202 specified in the API call. The API call may, for example, specify a user name utilized by the employee when accessing the user-accessed system 206. Accordingly, the reputation data processing system 208 in an embodiment may maintain data that associates internal identifiers of employees with corresponding user names of the user-accessed system 206. It should be noted, however, that the reputation data processing system and the user-accessed system may utilize the same identifier for a single employee. For example, the user-accessed system may be an internal system of the organization and a single identifier may be used by the reputation data processing system 208 and the user-accessed system 206.

As noted above, the reputation data processing system 208 may obtain data from the user-accessed system 206 in other ways such as by requesting a web page of the user-accessed system 206 and processing data from the web page accordingly. In another example, the reputation data processing system may request data in batches. For example, the organization may maintain an account with the user-accessed system 206. The reputation data processing system 208 may then, for example, submit an API call requesting current data for the account such as data for all employees of the organization having an account with the user-accessed system 206. Generally, the reputation data processing system 208 may obtain data from the user-accessed system 206 in any suitable manner including in manners not explicitly described herein. In addition, the data processing system may determine which received data to store in a persistent manner.

Data that has been stored and/or processed by the reputation data processing system 208 may be accessed by users 210 of the organization and/or users acting on behalf of the organization. Such users may be users interested in compliance of the organization, reputation of the organization and hiring for the organization and/or generally any users who utilize the reputation data processing system as part of their activities. Users may access the reputation data processing system through a browser or other application configured to submit requests for presentations of data to the reputation data processing system 208 which may then provide appropriate responses to the users.

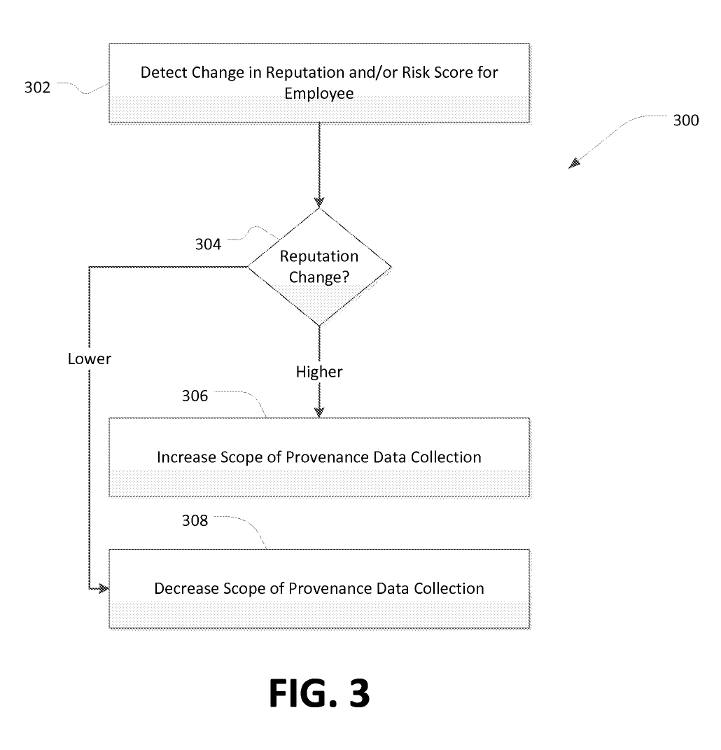

FIG. 3 accordingly shows an illustrative example of a process 300 for dynamically managing the amount of provenance data collected for individuals of an organization. The process 300 may be performed, for example, by a reputation data processing system such as described above. Some or all of the process 300 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an embodiment, the process 300 includes detecting 302 a change in a reputation and/or risk score for an employee. The reputation score may be a score that is calculated based at least in part on one or more reputation metrics. The reputation score may be configured such that reputation metrics affect the reputation score according to how the reputation metrics are considered as part of one's overall reputation. For example, if a higher reputation metric is generally has a positive effect on reputation, the reputation score can be configured such that the reputation score increases when the reputation metric increases (with all other components of the reputation score remaining constant). Similarly, the reputation score may be configured to decrease in accordance with reputation metrics changing in a way that is considered to contribute to a worsening overall reputation. As one example, the reputation score may be a linear combination of reputation metrics. As another example, the reputation score may be a series of reputation metrics multiplied together. Of course, more complicated functions of reputation metrics are considered as being within the scope of the present disclosure, such as reputation scores configured to take on values in a finite range, such as [0,1], [0,1), (0,1], and (0,1). Further, reputation scores can be used as an indication of risk. For instance, reputation scores that are high due to an employee's large sphere of influence can create a risk that the employee could easily damage the reputation of the employer. The reputation metrics may be values calculated based on the data that indicate something about the employee. The reputation metrics can indicate, for example, influence of the employee and/or risk of the employee. Example reputation metrics relating to impact and/or influence include generosity, influence, engagement, activity, impact and clout.

Generosity may be a reputation metric calculated based at least in part on a relative number of times the employee makes an effort to promote content of another. Examples of efforts to promote the content of another include sharing, in a social network, (e.g. Facebook, LinkedIn) content posted by another, re-tweeting a tweet in the Twitter social network, and otherwise taking action that promotes something of another. Generosity may be a relative value and, therefore, dependent on the actions of others. Generosity for an employee may be, for instance, calculated relative to other employees in a group, such as the whole organization, a department, employees sharing one or more characteristics (e.g. job title), and/or the like.

Influence, in an embodiment, is a reputation metric that indicates, in a relative manner, how often others promote the content of the employee. The influence value may be, for example, based on the number of tweets of the employee that are re-tweeted in the Twitter social network, the number of posts or other content of the employee that are shared in the Facebook social network, and/or other actions taken by others with respect to content associated with the employee. As with the generosity value and other values herein, the value may be calculated relative to a defined universe of users, which may or may not be limited to users of the organization.

Engagement, in an embodiment, is a reputation metric calculated based at least in part on actions taken by the employee that indicate engagement with others. Examples include commenting on content posted by others in various social networks, clicks on articles posted by others (to indicate having read the articles), and/or other actions determined to correspond to engagement by the employee.

Activity, in an embodiment, is a reputation metric that is calculated to be a relative value that is based at least in part on the number of times the employee posts content in one or more social networks relative to other users in some defined universe of users. The impact box may, for instance, may be calculated based at least in part on the influence reputation metric and additionally based at least in part on the size of the employee's social network. For example, the impact value may be based at least in part on the number of followers of the employee in the Twitter social network and at least in part on the number of times a follower re-tweets tweets of the employee. Thus, the impact value may be a relative value that increases both with increased social network size or increased activity of others in connection with content posted by the employee.

Clout, in an embodiment, is a reputation metric that is calculated using search engine metrics. In particular, search histories of users in a defined universe of users may be obtained to determine the frequency at which content of the employee appears in search results responsive to search queries submitted by others. The appearance of such content in search response rankings may also be used. Thus, the clout reputation metric, in an embodiment, corresponds to the clout of an employee as measured by the appearance of the employee's content in search responses. As with generosity and other metrics discussed above, this value may be calculated relative to defined group of employees. Further, the search engines may be operated by third parties.

While the above example reputation metrics may be used in calculations of risk (e.g. an employee with higher influence and/or clout may cause more damage by a violation of an organizational policy), other reputation metrics relate more directly to risk of an organization. Example reputation metrics are “no profanity,” disparagement, disclaimer use, confidentiality respect, reference respect and future offerings are provided. The “no profanity” reputation metric may be based at least in part on a profanity value that is calculated based at least in part on the number of posts of content by the employee and the number of those posts that contain a word considered to be profane. (Unless otherwise clear from context, post herein is to be understood generally and includes activity such as tweets and other activity of making content available). Whether a word is profane may be determined, for instance, by searching the content of the employee for words on a list of profane words. The “no profanity” metric may be calculated as (or at least based at least in part on) the ratio of posts of the employee containing profanity to the total number of posts of the employee. As with other metrics, posts may be calculated with respect to one or more social networks or other information sources.

The “non-disparagement” reputation metric, in an embodiment, corresponds to a disparagement value. The disparagement value may be calculated similar to the “no profanity” value, but instead of posts containing profanity being used, posts containing disparaging words and/or phrases are used. Determining whether a post contains disparaging words and/or phrases may be performed using semantic analysis of the posts, for instance by stemming words in the posts and searching for similar words in the same semantic topics. In other words, determining whether the posts contain disparaging words and/or phrases may be performed by determining whether the posts contain phrases that are semantically similar to known disparaging words and/or phrases.

The “use disclaimer” reputation metric, in an embodiment corresponds to a measure of activity relating to an employee's web log (blog), if the employee has a blog, and/or other electronic environment managed by the employee. An organization's social media policy may, for example, require bloggers that are also employees to make clear that the opinions expressed in the blog are not necessarily those of the organization. The employee may be required, for example, to include a predetermined disclaimer in each blog post and/or in a “terms and conditions” or other portion of a web site. The “use disclaimer” reputation metric, therefore, in an embodiment, may correspond to a value that is calculated based at least in part on the number of blog posts and the number of blog posts analyzed and calculated to lack the required disclaimer.

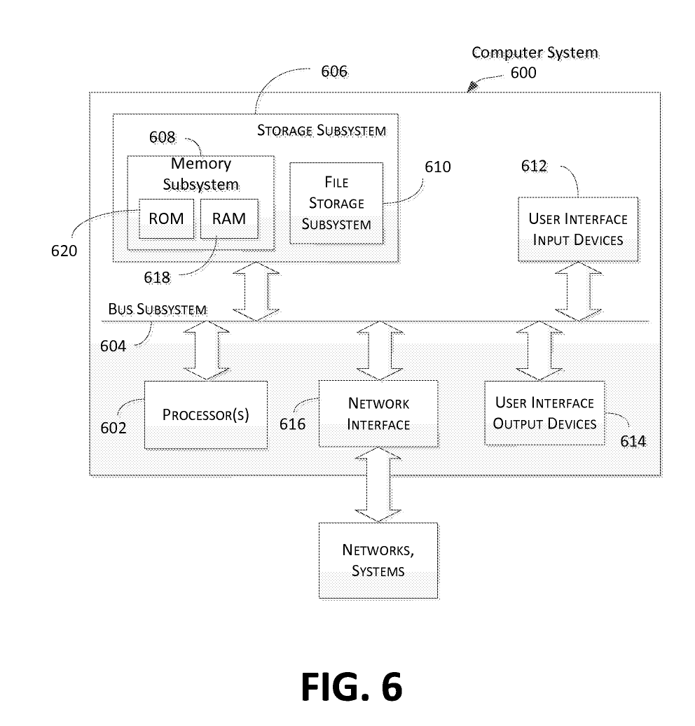

The “respect confidentiality” reputation metric, in an embodiment, as with other boxes, corresponds to a measure of certain activity calculated to contain one or more issues. In this instance, an issue is an instance of a post that, either inadvertently or intentionally, contains information that should be confidential. For example, posts containing the name of a company in which the organization is in confidential merger discussions may be marked as issue posts. Similarly, posts containing information about a future product release may be marked as issue posts. Determining whether a post contains confidential information may be performed by searching the posts for keywords of a list of keywords corresponding to confidential information. Such lists may be maintained by one or more individuals tasked with maintaining the organization's confidentiality. In addition, steps to obscure the terms from an administrator (e.g. user of the UI shown in FIG. 6) may be taken. For example, the administrator may be provided a list with dummy words and/or phrases. A reputation data processing system may convert the dummy words/phrases to actual words/phrases outside of the view of the administrator. Other ways of obscuring confidential information may also be used. Activities that may be examined for issues may include posts, articles, tweets, and/or generally any information made available to an unauthorized audience (e.g. the public and/or even those without authorization within the same organization).

The “respect references” reputation metric, in an embodiment, is also a value calculated based at least in part on a total number of posts and a number of those posts determined to contain one or more issues. In this example, a post may be considered to contain an issue if it lacks proper attribution and/or respects brand names. For example, a post may be considered to contain an issue by searching for a phrase of a predetermined minimum length and submitting the phrase to a search engine to determine whether the phrase is original. As another example, a post may be considered to contain an issue if the post includes a trademark without use of the trademark symbol ® or ™.

The “future offerings” reputation metric may be similarly be generated based at least in part on the number of posts and the number of posts determined to contain one or more particular issues. A post may be determined to contain an issue if the post contains information about a future product offering that is intended to remain confidential. The “future offerings” reputation may be calculated similar to the “respect confidentiality” box, but where the issues are limited to those dealing with future product offerings.

Returning to FIG. 3, the process 300 includes modifying the amount of data collected based at least in part on the detected change. For example, in an embodiment, the process 300 includes making a determination 304 whether there is a change in the reputation score. Determining whether there is a change in the reputation score may including determining whether the change is one that satisfies one or more conditions, such as exceeding a threshold amount of change and/or such as moving from one predefined range to another. If it is determined that the reputation score has increased, then the scope of provenance data collection is increased 308 accordingly. Similarly, if it is determined 304 that the reputation score for the employee has decreased, the scope of the provenance data collection is decreased 310 accordingly. It should be noted that, while increasing and decreasing the scope of the provenance data collection is described as occurring in connection with particular changes of a reputation score, the process 300 could be modified, for instance, to increase the scope of provenance data collection when the reputation score decreases, and vice versa. Such may be appropriate, for instance, if a reputation scores is configured such that lower reputation scores are considered better.

Changing the scope of the provenance data collection may be performed by making one or more configuration changes to a reputation data processing system, such as described above, that cause the reputation data processing system to modify one or more aspects for storing data in a reputation database. As an example, each employee may be allocated a certain amount of storage space in the reputation database. The allocated storage space may be used to store data about the employee and the data's origin. If the allocated storage space is filled, one or more techniques for replacing older data with new data may be used. For example, the allocated storage space may be operated on a first-in-first-out (FIFO) basis. As another example, data may be prioritized based on some calculation of importance such that higher priority data replaces lower priority data. Accordingly, performance of the process 300 may result in the amount of storage space allocated to a particular employee (whose reputation score changed) to be modified in accordance with his or her reputation score. It should be noted that, in this example, the allocations to other employees may change also, for instance, to accommodate an increased allocation for the employee whose reputation score changed in a manner requiring additional storage space.

In addition, changing the scope of provenance data collection may be performed by one or more configuration changes to the data processing system that cause the reputation data processing system to change one or more conditions for storing data regarding an employee and the data's source. For instance, the reputation data processing system may be configured to collect content resulting from certain types of actions (e.g. Facebook posts, tweets, etc.). To change the amount of data collected, the set of actions for which data is collected may be increased or decreased, as appropriate. For example, to increase the amount of data collected, the reputation data processing system may be reconfigured to collect from Twitter not only tweets of an employee (that is, tweets composed by the employee), but re-tweets of others' tweets as well. Further, some data is more important to an organization's reputation than other data. For instance, a Facebook post about the weather may be benign, but an employee's Facebook filled with profanity and directed to the employee's employer could damage the employer's reputation. Accordingly, changing the scope of provenance data collection may be performed by changing one or more conditions on content associated with the employee that, when met, cause the content along with data about its source to be collected. Profanity, for instance, can have varying degrees of severity, with some words/phrases being relatively benign (yet still profane) while other words/phrases can be quite harmful, with many words/phrases falling in between. Changing the scope of provenance data collection may, therefore, be performed by changing the conditions on a metric of profanity so that, to collect more data, the conditions for being profane are relaxed and to collect less data, the conditions for being profane are made stricter.

As yet another example, the scope of provenance data collection may be varied by changing the set of sources from which data is collected. For example, an employee may disclose some of his/her social network (and/or other) profiles to his/her employer, but not others. The employer may (e.g. through automated, semi-automated, or other ways) discover non-disclosed profiles that are potentially associated with the employee. Unless the employee expressly indicates ownership of the non-disclosed profiles, determinations may have to be made whether the profiles are, in fact, associated with the employee. While such determinations may be made in a Boolean fashion, Boolean determinations do not necessarily account for varying degrees of certainty of association with the employee. Accordingly, in an embodiment, non-disclosed profiles are analyzed and analyzed and given a score that is indicative of certainty that the non-disclosed profiles are associated with the employee. A score of 1 may, for example, represent near absolute certainty of a profile's association with an individual while a score of 0.5 may indicate some certainty, but a larger probability that a profile is actually associated with another individual. Changing the scope of provenance data collection may, for example, raise or lower a threshold of such a score so that, to collect more data related to an individual, more uncertainty in whether a profile matches the individual may be tolerated and, to collect less data, less uncertainty may be tolerated.

As yet another example of how the scope of provenance data collection may be changed, the set of data sources from which data is collected may be changed in other ways. For example, some social networks (e.g. Facebook) are considered to be more social while other social networks (e.g. LinkedIn) are considered to be more professional. Accordingly, employee posts in LinkedIn may be considered by some businesses as being potentially more dangerous to the businesses' reputation than employee posts in Facebook. Generally, in some circumstances, employee behavior in connection with one data source may be considered to be more dangerous to an organization than employee behavior in connection with other data sources. Accordingly, changing the scope of provenance data collection may be performed by excluding data sources and/or including additional data sources.

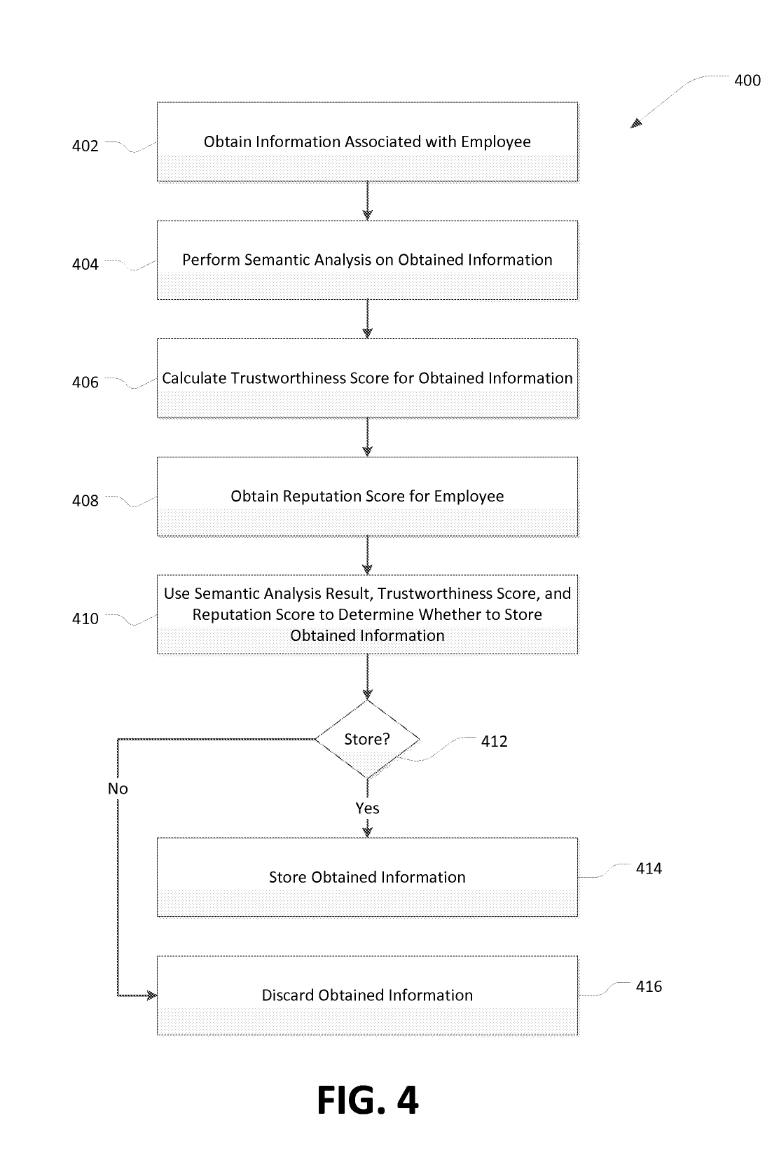

FIG. 4 shows an illustrative example of a process 400 for dynamically storing information obtained from various data sources in accordance with various embodiments. In an embodiment, the process 400 included obtaining 402 information associated with an employee. The information associated with the employee may be obtained in any suitable manner, such as by obtaining from internal and/or external data sources such as described above. The data associated with the employee may be provided in various forms. For example, the data may be structured, that is, organized according to a known scheme. The data may also be unstructured. For example, the employee may include compositions by the employee of short posts posted in a social networking context or online forum. Semantic analysis may be then performed 404 on the obtained information. Semantic analysis may including stemming words from the obtained data, using an ontology to match the words to topics, and use the matched topics to make determinations whether the words are semantically similar to a predetermined set of words, such as a set of words determined to be disparaging. Similarly, semantic analysis may analyze phrases to determine whether the phrases are semantically similar to phrases determined to be associated with risk to an organization, such as phrases regarding a potential merger and/or acquisition, phrases regarding a product launch, etc. Generally, semantic analysis can be performed in any suitable manner to provide one or more results, such as determinations and/or scores indicating potential risk to an organization. Other analyses, such as keyword matching to identify data related to confidential product releases or mergers or acquisitions, may also be performed although it is not illustrated as such in FIG. 4.

In an embodiment, a trustworthiness score is calculated 406 for the obtained information. The trustworthiness score may be calculated based at least in part on the obtained information. For example, the trustworthiness score may be calculated based at least in part on whether the source of the information is a source identified by the employee, by whether or not the information includes information unique to the employee, a trustworthiness score is stored for the source of the obtained information and the like. The trustworthiness score may be, for example, a score configured to indicate whether the source is associated with the employee (e.g. whether the source matches another source known and/or likely to be associated with the employee), where a higher score indicates a higher certainty of the association.

A reputation score for the employee may be obtained 408. The reputation score may be obtained in any suitable manner, such as by calculating the reputation score or accessing the reputation score from a data store. The result of the semantic analysis, the trustworthiness score, and the reputation score may be used 410 to determine 412 whether to store the information that was obtained. Determining whether to store the information may be performed in any suitable manner. For example, each of the semantic analysis result, trustworthiness score, and reputation score may be determinative of whether to store the obtained information. In this example, certain semantic analysis results (e.g. results that are particularly severe or otherwise calculated to be noteworthy) may cause the obtained information to be stored regardless of the reputation and trustworthiness scores. In other examples, more complex conditions may be placed on two or three (or more, if more are used in some embodiments) of the scores to determine whether to store the obtained information. For instance, a requirement of the stored information may be that multiple (perhaps all) of the scores exceed some defined threshold, which may be configurable by an administrator, such as a user interface discussed above. As another example, conditions may be configured such that higher reputation scores require lower trustworthiness scores than what is necessary for lower reputation scores. More generally, the conditions for one or more scores may be relaxed based at least in part on one or more other scores.

If it is determined 412 to store the obtained information, then the obtained information is stored 414 in an appropriate data store, such as a reputation database as described above. Similarly, if it is determined 412 not to store the obtained information, the obtained information is discarded 416. Discarding the information may be performed in any suitable manner, such as by not storing the information in a reputation data store and/or by allowing the information to be overwritten in computer memory.

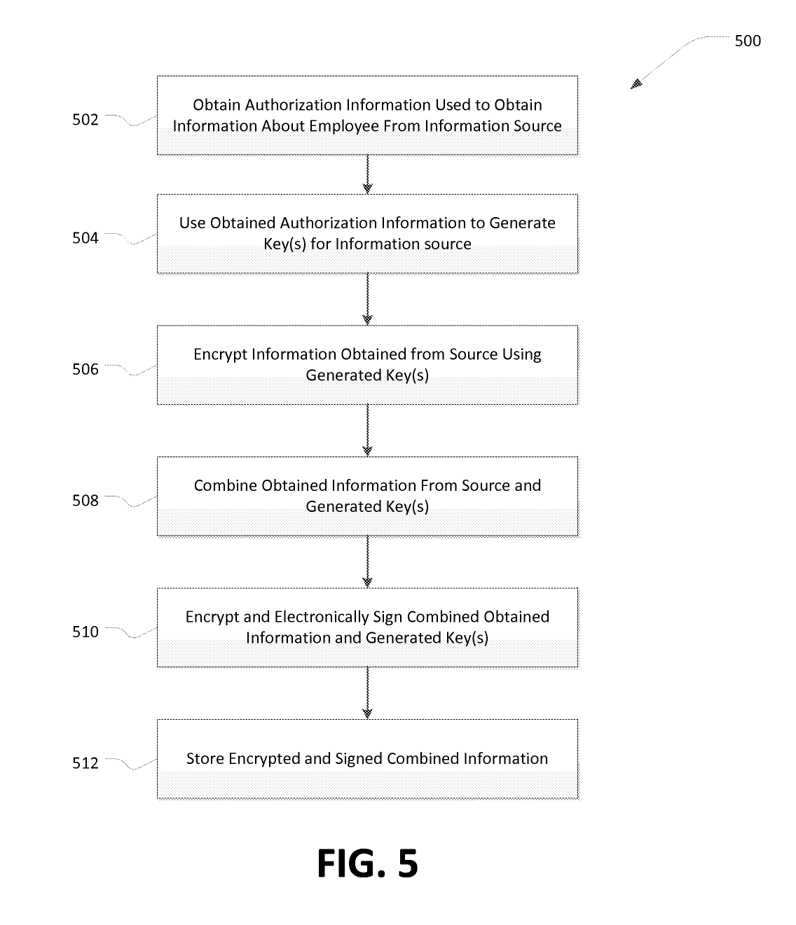

Various embodiments of the present disclosure also relate to information collection in a secure manner. FIG. 5 accordingly shows an illustrative example of a process 500 for securely storing information about an employee. In an embodiment, the process 500 includes obtaining 502 authorization information used to obtain information about the employee from an information source (e.g. from a data source such as described above). For example, obtaining information from an external data source or internal source often involves various methods of authentication. A token or other value may be passed from a system obtaining the information to the source of the information. Similarly, the authentication information may comprise credentials may be used to access information from an information source. Generally, any information used for the purpose of authentication in connection with obtaining information from an information source may be used.

In an embodiment, the process 500 includes using 504 the obtained authorization information to generate one or more keys for the information source. The keys may be generated in any suitable manner. For example, a key derivation function such as password-based key derivation function 2 (PBKDF2) may be used to generate the one or more keys. Other example suitable key derivation functions include KDF1, KDF2, KDF3, KDF4, MGF1, PBKDF-Schneier, and PBKDF1. The information obtained from the source may be encrypted 506 using the generated one or more keys. Any suitable encryption algorithm may be used. For example, any suitable symmetric-key cryptography algorithm, such as the data encryption standard (DES), the advanced encryption standard (AES), triple-DES, may be used. Asymmetric key cryptography algorithms, such as RSA may also be used with key generation being performed accordingly to produce suitable keys.

The information from the source and the generated keys may then be combined 508 into some encoding that encodes the combination of the obtained information and generated keys. The combined obtained information and generated one or more keys may then be encrypted and electronically signed and the encrypted and signed combined information may then be stored 512. One with skill in the art will understand that by storing appropriate keys and certificates, the process 500 may be undone to obtain encrypted information through appropriate decoding processes depending on which processes were used to encrypt the information.

FIG. 6 is a simplified block diagram of a computer system 600 that may be used to practice an embodiment of the present invention. Computer system 600 may serve as a reputation data processing system, or component computer system instance thereof, such as described above and/or a computer system that presents a user interface in accordance with the various embodiments described herein. Computer system 600 may also perform various cryptographic operations described herein and compute various determinations regarding the storage of data. For example, computer system 600 may make determinations whether to store information about individuals and/or data regarding the source of the information. As shown in FIG. 6, computer system 600 includes a processor 602 that communicates with a number of peripheral subsystems via a bus subsystem 604. These peripheral subsystems may include a storage subsystem 606, comprising a memory subsystem 608 and a file storage subsystem 610, user interface input devices 612, user interface output devices 614, and a network interface subsystem 616.

Bus subsystem 604 provides a mechanism for letting the various components and subsystems of computer system 600 communicate with each other as intended. Although bus subsystem 604 is shown schematically as a single bus, alternative embodiments of the bus subsystem may utilize multiple busses.

Network interface subsystem 616 provides an interface to other computer systems, networks, and portals. Network interface subsystem 616 serves as an interface for receiving data from and transmitting data to other systems from computer system 600. The network interface subsystem 616, for example, may enable the computer system 600 to communicate with other computer systems over a network, such as to obtain data from various data sources and/or to communicate with other components of a reputation data processing system.

User interface input devices 612 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 600. A user may use an input device to provide user input to interact with a user interface to perform various activities described above.

User interface output devices 614 may include a display subsystem, a printer, a fax machine, or non-visual displays such as audio output devices, etc. The display subsystem may be a cathode ray tube (CRT), a flat-panel device such as a liquid crystal display (LCD), a light emitting diode (LED) display, a projection device, and/or another device capable of presenting information. In general, use of the term “output device” is intended to include all possible types of devices and mechanisms for outputting information from computer system 600. Presentations generated in accordance with the various embodiments described herein, for example, may be presented using output devices 614.

Storage subsystem 606 provides a computer-readable medium for storing the basic programming and data constructs that provide the functionality of the present invention. Software (programs, code modules, instructions) that when executed by a processor provide the functionality of the present invention may be stored in storage subsystem 606. These software modules or instructions may be executed by processor(s) 602. Storage subsystem 606 may also provide a repository for storing data used in accordance with the present invention, for example, the data stored in the diagnostic data repository. For example, storage subsystem 606 provides a storage medium for persisting data that is analyzed to calculate various reputation metrics and/or reputation values. Storage subsystem 606 may comprise memory subsystem 608 and file/disk storage subsystem 610.

Memory subsystem 608 may include a number of memory components including a main random access memory (RAM) 618 for storage of instructions and data during program execution and a read only memory (ROM) 620 in which fixed instructions are stored. File storage subsystem 610 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 600 can be of various types including a personal computer, a portable computer, a smartphone, a table computing device, a workstation, a network computer, a mainframe, a kiosk, a server or any other data processing system. Due to the ever-changing nature of computers and networks, the description of computer system 600 depicted in FIG. 6 is intended only as a specific example for purposes of illustrating the preferred embodiment of the computer system. Many other configurations having more or fewer components than the system depicted in FIG. 6 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims.

What is claimed is:

1. A method for dynamically managing an amount of provenance data collected for employees of an enterprise, the method comprising:
maintaining a reputation score for an employee of the enterprise, the reputation score comprising an indication of a risk associated with the employee;
detecting a change in the reputation score for the employee; and
changing a scope of the set of provenance data collected for the employee based on detecting the change in the reputation score for the employee when the detected change exceeds a threshold amount of change.

2. The method of claim 2, wherein changing the scope of the set of provenance data collected for the employee comprises increasing the scope of the set of provenance data collected for the employee when the reputation score for the employee increases and decreasing the scope of the set of provenance data collected for the employee when the reputation score for the employee decreases.

3. The method of claim 2, wherein changing the scope of the set of provenance data collected for the employee comprises modifying one or more aspects of storing data related to the employee in a reputation database.

4. The method of claim 2, wherein changing the scope of the set of provenance data collected for the employee comprises changing one or more conditions for storing data related to the employee in a reputation database and one or more sources of the data related to the employee.

5. The method of claim 2, wherein changing the scope of the set of provenance data collected for the employee comprises changing one or more sources of data related to the employee.

6. The method of claim 1, wherein maintaining the reputation score for the employee comprises:
obtaining information associated with the employee from each of a plurality of data sources, wherein the plurality of data sources include at least one data source internal to the enterprise and at least one data source external to the enterprise;
performing a semantic analysis on the obtained information;
calculating a trustworthiness score for the obtained information, the trustworthiness score indicating whether the source of the obtained information is likely to be associated with the employee;
obtaining the reputation score for the employee; and
determining whether to store the obtained information based at least in part on the semantic analysis, the trustworthiness score, and the reputation score.

7. The method of claim 6, wherein maintaining the reputation score for the employee further comprises:
obtaining authorization information, the authorization information used to obtain the information associated with the employee from each of the plurality of data sources;
generating one or more keys using the authorization information;
encrypting the obtained information about the employee using the generated one or more keys; and
storing the encrypted obtained information about the employee.

8. The method of claim 7, wherein the trustworthiness score is related to one or more of the source of information, the author of the information, or the reputation of the source or the author of the information.

9. The method of claim 7, further comprising mapping one or more reputation scores to a single trustworthiness score.

10. The method of claim 7, further comprising storing the trustworthiness score with the stored information and as part of the provenance information for use in further analysis.

11. A system comprising:
a processor; and
a memory coupled with and readable by the processor and storing therein a set of instructions which, when executed by the processor, causes the processor to dynamically manage an amount of provenance data collected for employees of an enterprise by:
maintaining a reputation score for an employee of the enterprise, the reputation score comprising an indication of a risk associated with the employee;
detecting a change in the reputation score for the employee; and
changing a scope of the set of provenance data collected for the employee based on detecting the change in the reputation score for the employee when the detected change exceeds a threshold amount of change.

12. The system of claim 12, wherein changing the scope of the set of provenance data collected for the employee comprises increasing the scope of the set of provenance data collected for the employee when the reputation score for the employee increases and decreasing the scope of the set of provenance data collected for the employee when the reputation score for the employee decreases.

13. The system of claim 12, wherein changing the scope of the set of provenance data collected for the employee comprises modifying one or more aspects of storing data related to the employee in a reputation database.

14. The system of claim 12, wherein changing the scope of the set of provenance data collected for the employee comprises changing one or more conditions for storing data related to the employee in a reputation database and one or more sources of the data related to the employee.

15. The system of claim 12, wherein changing the scope of the set of provenance data collected for the employee comprises changing one or more sources of data related to the employee.

16. The system of claim 11, wherein maintaining the reputation score for the employee comprises:
obtaining information associated with the employee from each of a plurality of data sources, wherein the plurality of data sources include at least one data source internal to the enterprise and at least one data source external to the enterprise;
performing a semantic analysis on the obtained information;
calculating a trustworthiness score for the obtained information, the trustworthiness score indicating whether the source of the obtained information is likely to be associated with the employee;
obtaining the reputation score for the employee; and
determining whether to store the obtained information based at least in part on the semantic analysis, the trustworthiness score, and the reputation score.

17. The system of claim 16, wherein maintaining the reputation score for the employee further comprises:
obtaining authorization information, the authorization information used to obtain the information associated with the employee from each of the plurality of data sources;
generating one or more keys using the authorization information;
encrypting the obtained information about the employee using the generated one or more keys; and
storing the encrypted obtained information about the employee.

18. The system of claim 17, wherein the trustworthiness score is related to one or more of the source of information, the author of the information, or the reputation of the source or the author of the information.

19. The system of claim 17, further comprising mapping one or more reputation scores to a single trustworthiness score.

20. The system of claim 17, further comprising storing the trustworthiness score with the stored information and as part of the provenance information for use in further analysis.
